(19) United States
(12) Patent Application Publication
(10) Pub. No.: US 2015/0089655 A1
(43) Pub. Date: Mar. 26, 2015

(54) SYSTEM AND METHOD FOR DETECTING MALWARE BASED ON VIRTUAL HOST

(71) Applicant: ELECTRONICS AND TELECOMMUNICATIONS RESEARCH INSTITUTE, Daejeon (KR)

(72) Inventors: Young Han CHOI, Daejeon (KR); Haksoo KIM, Cheonan-si (KR); Deokjin KIM, Daejeon (KR); JungMin KANG, Daejeon (KR); HyungGeun OH, Daejeon (KR); Kiwook SOHN, Daejeon (KR)

(21) Appl. No.: 14/492,177

(22) Filed: Sep. 22, 2014

(30) Foreign Application Priority Data
Sep. 23, 2013 (KR) 10-2013-0112607

(51) Int. Cl. H04L 29/06; G06F 21/56

(52) U.S. Cl. CPC H04L 63/145; G06F 21/566; H04L 63/1425
USPC 726/24

(57) ABSTRACT

A system and method for detecting malware based on a virtual host are provided. The system for detecting malware based on a virtual host includes a terminal network behavior analysis server and a virtual host. The terminal network behavior analysis server extracts network behavior information by monitoring the network behavior of an actual host, and outputs the extracted the network behavior information. The virtual host detects malware corresponding to abnormal behavior in the actual host, by receiving the network behavior information and then performing corresponding behavior.

### CROSS-REFERENCE TO RELATED APPLICATION

This application claims the benefit of Korean Patent Application No. 10-2013-0112607, filed on Sep. 23, 2013, which is hereby incorporated by reference herein in its entirety.

### BACKGROUND OF THE INVENTION

1. Technical Field

The present disclosure relates generally to a system and method for detecting malware based on a virtual host and, more particularly, to a system and method that are capable of detecting the installation and behavior of malware using a virtual host PC without installing a detection agent for monitoring behavior in an actual host PC.

2. Description of the Related Art

Conventional dynamic analysis-based malware detection schemes detect malware chiefly in such a way as to install and then operate the lowest version of target software in a virtualized environment. The reason for this is that even the newest vulnerability operates in the lowest version of software.

However, in the case of a cyber attack targeted at a specific user, it is possible to reproduce a cyber attack targeted for a specific user only if an environment is identical to that of a target PC.

Furthermore, conventional malware detection in a terminal PC always monitors operation in order to perform real-time detection, thereby frequently imposing overload on a host PC. The reason for this is that excessive information is extracted from the operating flow of software in order to perform real-time detection. Therefore, the conventional malware detection obstructs the normal performance of tasks on a user PC.

As a related technology, U.S. Patent Application Publication No. 2012-0180131 entitled “System, Method, and Computer Program Product for Identifying Unwanted Activity utilizing a Honeypot Device accessible via VLAN Trunking” discloses a technology for identifying the malicious behavior of terminals present on a virtual network using an honeypot device in an environment in which a virtual local area network (VLAN) has been constructed.

The technology disclosed in U.S. Patent Application Publication No. 2012-0180131 assumes that a firewall present at a point at which an external network is connected performs the function of completely detecting and blocking malicious behavior that attempts to make access from the external network to an internal network in which a VLAN has been constructed. As a result, the technology disclosed in U.S. Patent Application Publication No. 2012-0180131 is configured to construct the honeypot device in the VLAN environment without considering malicious behavior that attempts to make access from the external network to the internal network, thereby detecting only the malicious behavior of an accessing terminal on a virtual network. That is, the technology disclosed in U.S. Patent Application Publication No. 2012-0180131 focuses on malicious behavior within the internal network without taking into account threats from the external network.

### SUMMARY OF THE INVENTION

Accordingly, at least one embodiment of the present invention is intended to provide a system and method for detecting malware based on a virtual host, which are capable of detecting malware by reproducing the network behavior of an actual host in a virtual host whose software installation and version information have been synchronized with those of the actual host.

In accordance with an aspect of the present invention, there is provided a system for detecting malware based on a virtual host, including a terminal network behavior analysis server configured to extract network behavior information by monitoring the network behavior of an actual host, and to output the extracted the network behavior information; and a virtual host configured to detect malware corresponding to abnormal behavior in the actual host, by receiving the network behavior information and then performing corresponding behavior.

The virtual host may synchronize the software installation information and version information thereof with the software installation information and version information of the actual host in order to perform network behavior of the actual host in an identical manner.

The network behavior information may include information attributable to behavior in which the actual host accesses a website and information attributable to behavior in which the actual host reads a file over a network.

The information attributable to behavior in which the actual host accesses a website may include an Internet Protocol (IP) address and a uniform resource locator (URL).

The information attributable to behavior in which the actual host reads a file over a network may include a file included in a network packet.

The system may further include a terminal software state collection server configured to maintain information about the installation and versions of software installed on the actual host.

The terminal software state collection server may additionally store the original of software installed in the actual host.

The virtual host may receive software installation information from the terminal software state collection server, and may then perform synchronization of software.

If the information about installation of software installed in the actual host changes, the terminal software state collection server may request the virtual host to change the state of the installed software by providing notification.

In accordance with another aspect of the present invention, there is provided a method of detecting malware based on a virtual host, including extracting, by a terminal network behavior analysis server, network behavior information by monitoring network behavior of an actual host; transferring, by the terminal network behavior analysis server, the extracted the network behavior information to the virtual host; and detecting, by the virtual host, malware corresponding to abnormal behavior in the actual host, by receiving the network behavior information and then performing corresponding behavior.

The network behavior information may include information attributable to behavior in which the actual host accesses a website and information attributable to behavior in which the actual host reads a file over a network.

The information attributable to behavior in which the actual host accesses a website may include an IP address and a URL.

The information attributable to behavior in which the actual host reads a file over a network may include a file included in a network packet.

The method may further include, before detecting the malware corresponding to the abnormal behavior, performing, by the virtual host, synchronization with the actual host with respect to information about installation and versions of software in order to perform network behavior of the actual host in an identical manner.

The method may further include, before detecting the malware corresponding to the abnormal behavior, maintaining, by the terminal software state collection server, information about installation and versions of software installed on the actual host.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating a configuration to which a system for detecting malware based on a virtual host has been applied according to an embodiment of the present invention;

FIG. 2 is a flowchart illustrating the process of performing synchronization in the installation and versions of software between the actual host and the virtual host illustrated in FIG. 1;

FIG. 3 is a flowchart illustrating the process of detecting malware in a virtual host through the analysis of the network behavior of the actual host illustrated in FIG. 1; and

FIG. 4 is a diagram illustrating the operation of the virtual host illustrated in FIG. 1.

### DESCRIPTION OF THE PREFERRED EMBODIMENTS

Embodiments of the present invention are described with reference to the accompanying drawings in order to describe the present invention in detail so that those having ordinary knowledge in the technical field to which the present invention pertains can easily practice the present invention. It should be noted that the same reference numerals are used to designate the same or similar elements throughout the drawings. In the following description of the present invention, detailed descriptions of known functions and configurations which are deemed to make the gist of the present invention obscure will be omitted.

Prior to the following detailed description of the present invention, it should be noted that the terms and words used in the specification and the claims should not be construed as being limited to ordinary meanings or dictionary definitions. Meanwhile, the embodiments described in the specification and the configurations illustrated in the drawings are merely examples and do not exhaustively present the technical spirit of the present invention. Accordingly, it should be appreciated that there may be various equivalents and modifications that can replace the embodiments and the configurations at the time at which the present application is filed.

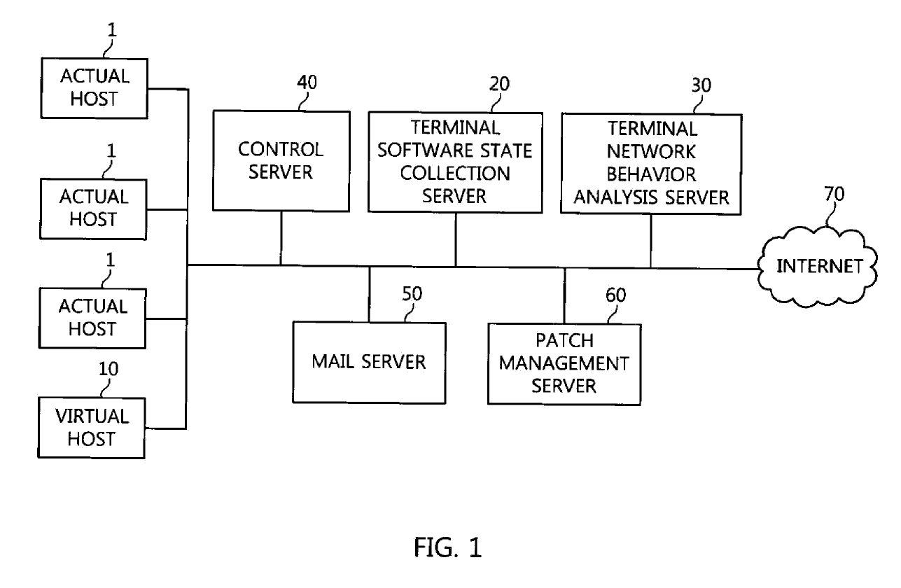

FIG. 1 is a diagram illustrating a configuration to which a system for detecting malware based on a virtual host has been applied according to an embodiment of the present invention.

The configuration of FIG. 1 includes the actual hosts 1, a virtual host 10, a terminal software state collection server 20, a terminal network behavior analysis server 30, a control server 40, a mail server 50, and a patch management server 60.

The actual hosts 1 are hosts that are actually used by a user, and may be, for example, personal computers (PC), notebook computers, and/or the like. A user may actually perform desired tasks by manipulating the actual hosts 1.

In the virtual host 10, the software installation information (for example, installation paths, installed files (for example, executable files, etc.), installed files-related registry information, etc.) and version information of the actual hosts 1 are maintained in identical states. The virtual host 10 is an automated PC that is not operated by an actual user.

The virtual host 10 operates in a virtualized environment in order to support the various actual hosts 1 that are being monitored.

The virtual host 10 receives software installation information from the terminal software state collection server 20, and performs the synchronization of software.

Furthermore, the virtual host 10 may access the patch management server 60 within an organization, which is accessed by the actual hosts 1, and may update software.

The virtual host 10 functions to perform the network behavior of each of the actual hosts 1 in an identical manner and to detect malware that is installed and operated when the corresponding behavior is performed. In this case, the network behavior may include accessing a website accessed by each of the actual hosts 1 in the same manner and reading a file over a network (for example, the Internet 70).

The terminal software state collection server 20 maintains the name and version information of software actually installed in each of the hosts 1 for each user.

The terminal software state collection server 20, if the installation information of software of the actual host 1 has changed, requests the virtual host 10 to change the state of the software installed in the corresponding system by providing notification to the virtual host 10.

Meanwhile, the terminal software state collection server 20 stores the original of software that is installed the actual host 1. Such a software original file is manually stored when it is installed offline. In the case of a file that is installed over a network, the terminal network behavior analysis server 30 extracts the corresponding file. In this case, when the corresponding file is an installation-related file, the terminal network behavior analysis server 30 transfers the corresponding file to the terminal software state collection server 20, and thus the corresponding file may be stored in the terminal software state collection server 20.

The terminal network behavior analysis server 30 extracts IP and URL information assessed by the actual host 1 by monitoring the network behavior of the actual host 1, and extracts a corresponding file from a packet when the file is included in the network packet.

Furthermore, terminal network behavior analysis server 30 may extract an attached file extracted by the mail server 50.

The terminal network behavior analysis server 30 transfers the extracted information of the actual host 10 to the virtual host 10. In this case, the transferred information includes information about a website (for example, an IP address, a URL, etc.) accessed by the actual host 1 and the, extracted file.

Since the above-described terminal software state collection server 20 and the terminal network behavior analysis server 30 support the malware detection process of the virtual host 10, they may be collectively referred to as a virtual host support server.

The control server 40 performs control so that the virtual host 10, the terminal software state collection server 20 and the terminal network behavior analysis server 30 can normally operate. For example, the control server 40 may control the load balancing of the installed virtual host 10, and may perform control on whether the virtual host support server normally operates.

Although the terms “terminal software state collection server,” “terminal network behavior analysis server,” “control server,” “mail server,” and “patch management server” have been described in the above-described FIG. 1, the term “unit” may be used instead of the term “server.”

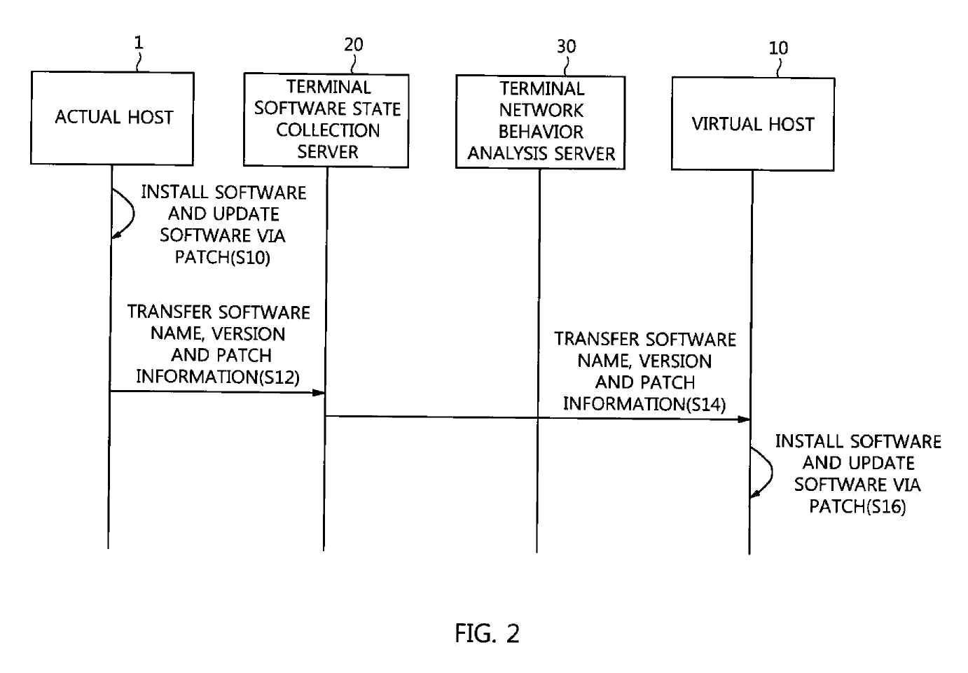

FIG. 2 is a flowchart illustrating the process of performing synchronization in the installation and versions of software between the actual host and the virtual host illustrated in FIG. 1.

First, in the actual host 1, software is installed or software is updated via a patch at step S10.

Thereafter, information about software installed on the actual host 1 is transferred to the terminal software state collection server 20 at step S12. As a result, the terminal software state collection server 20 receives information about the software installed on the actual host 1. In this case, the received information includes a software name, a version, and patch information.

Then the terminal software state collection server 20 transfers the received information about the software of the actual host Ito the virtual host 10 at step S14. If the information about the software installed on the actual host 1 changes, the terminal software state collection server 20 transfers the changed information about the software of the actual host 1 to the virtual host 10.

Accordingly, the virtual host 10 installs software or performs software update via a patch based on the received information about the software of the actual host 1 at step S16. For example, the virtual host 10 downloads the software from the terminal software state collection server 20 and then installs the software in the case of the installation of software, or downloads the software via the Internet and then performs update,

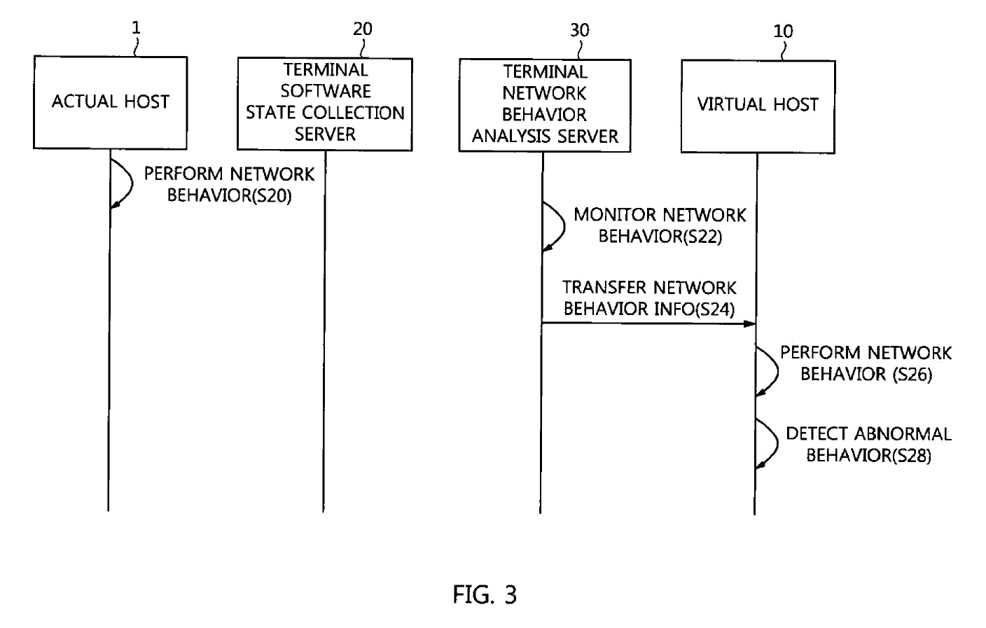

FIG. 3 is a flowchart illustrating the process of detecting malware in the virtual host through the analysis of the network behavior of the actual host illustrated in FIG. 1. The process of detecting malware, which is described below, may be understood to be performed after the process of performing synchronization in the installation and versions of software between the actual host 1 and the virtual host 10, which has been described in conjunction with FIG. 2.

First, a user performs predetermined network behavior (for example, the accessing of a website, the reading of a file, or the like) by manipulating one of the actual hosts 1 at step S20.

Accordingly, the terminal network behavior analysis server 30 extracts corresponding network behavior information by monitoring the network behavior of the actual host 1 at step S22. In this case, network behavior information includes an accessed IP address, a URL, a file included in a packet, etc.

Thereafter, the terminal network behavior analysis server 30 transfers the extracted network behavior information to the virtual host 10 that maintains the same software state as the actual host 1 at step S24.

As a result, the virtual host 10 performs corresponding network behavior based on the received network behavior information at step S26. For example, the virtual host 10 may access a corresponding point when the network behavior information is an IP address and a URL, or the virtual host 10 may perform the operation of reading a file when the network behavior information is the corresponding file.

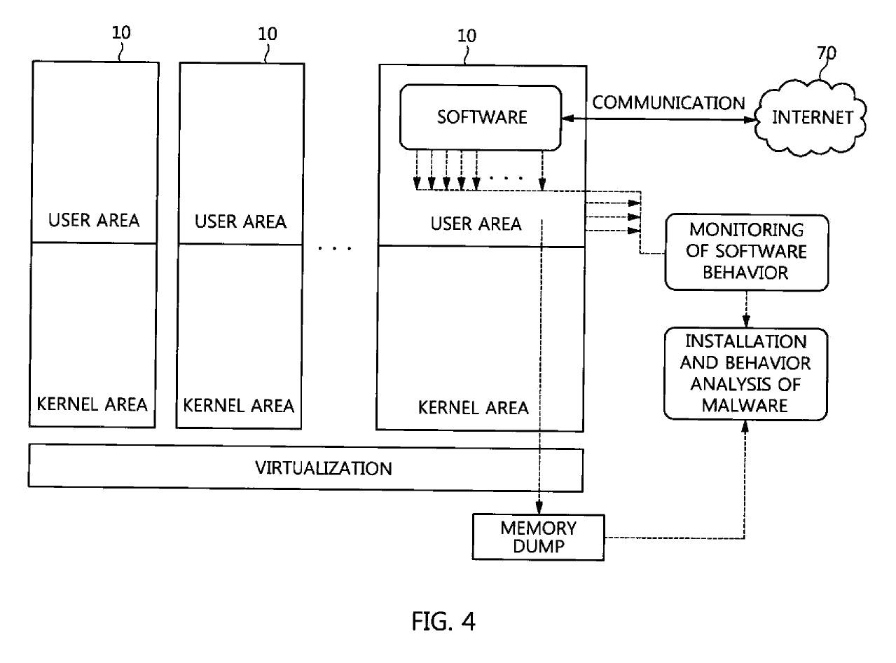

Finally, the virtual host 10 detects abnormal behavior while performing network behavior at step S28. When the virtual host 10 detects abnormal behavior, the virtual host 10 may detect malware corresponding to the corresponding abnormal behavior. In this case, the abnormal behavior relates to the creation of an abnormal file, the creation of a new process, the installation of a malicious file, or the operation of a malicious file. The exemplified abnormal behavior may be considered to be generated based on corresponding malware. Furthermore, it will be readily understood by those skilled in the art that the detection of the generation of an abnormal file or a new process, the installation of a malicious file, or the operation of a malicious file is easily implemented by technology known in the art. Furthermore, since technology of detecting malware in a PC is known, the detection of malware based on abnormal behavior may be easily implemented. Accordingly, the detection of malware in the virtual host 10 is described through the description of FIG. 4, which is given below.

FIG. 4 is a diagram illustrating the operation of the virtual host illustrated in FIG. 1.

Since the virtual hosts 10 need to synchronize the state of the software of all actual hosts 1 to be monitored, the number of virtual hosts 10 needs to be equal to the number of all objects to be monitored, that is, the number of actual hosts 1.

Each of the virtual hosts 10 operates in a virtualized environment in order to detect malware in a user area and a kernel area.

The virtual host 10 performs behavior, such as the installation and update of software. Such behavior is monitored by hooking. Furthermore, malware is detected by periodically performing memory dump during execution in order to detect a kernel device driver, such as a rootkit, and hidden malware, such as code injection. In this case, the rootkit is a tool (a program or the like) that is used to prevent a system user from being aware of being hacked by a hacker, and the code injection is the injection of code into a target process.

As described above, in accordance with the present invention, information about the actual installation and version of software in each of the actual hosts 1 is synchronized with information about the software of the virtual host 10, and the network behavior of the actual host 1 is reproduced in the virtual host 10 in the same manner, thereby detecting malware that may be installed and operated on the actual host 1.

Furthermore, in accordance with the present invention, a state identical to the state of the installation of software of the actual host 1 is maintained in the virtual host 10 and then the network behavior of the virtual host 10 is monitored, and thus the burden in which an agent should operate in the actual host 1 can be removed.

In accordance with the present invention configured as described above, the network behavior of the actual host is reproduced in the virtual host whose information about the actual installation and version of software has been synchronized with those of the virtual host, thereby reducing the execution load of the actual host.

That is, a state identical to the state of the installation of software of the actual host is maintained in the virtual host and then the behavior of the virtual host is monitored, and thus the burden in which an agent should operate in the actual host can be removed.

Furthermore, the reduction of performance and instability attributable to a detection agent can be eliminated from the actual host.

Although the preferred embodiments of the present invention have been disclosed for illustrative purposes, those skilled in the art will appreciate that various modifications, additions and substitutions are possible without departing from the scope and spirit of the invention as disclosed in the accompanying claims.

What is claimed is;

1. A system for detecting malware based on a virtual host, comprising:
a terminal network behavior analysis server configured to extract network behavior information by monitoring network behavior of an actual host, and to output the extracted the network behavior information; and
a virtual host configured to detect malware corresponding to abnormal behavior in the actual host, by receiving the network behavior information and then performing corresponding behavior.

2. The system of claim I, wherein the virtual host synchronizes software installation information and version information thereof with software installation information and version information of the actual host in order to perform network behavior of the actual host in an identical manner.

3. The system of claim 1, wherein the network behavior information comprises information attributable to behavior in which the actual host accesses a website, and information attributable to behavior in which the actual host reads a file over a network.

4. The system of claim 3, wherein the information attributable to behavior in which the actual host accesses a website comprises an Internet Protocol (IP) address and a uniform resource locator (URL).

5. The system of claim 3, wherein the information attributable to behavior in which the actual host reads a file over a network comprises a file included in a network packet.

6. The system of claim 1, further comprising a terminal software state collection server configured to maintain information about installation and versions of software installed on the actual host.

7. The system of claim 6, wherein the terminal software state collection server additionally stores an original of software installed in the actual host.

8. The system of claim 6, wherein the virtual host receives software installation information from the terminal software state collection server, and then performs synchronization of software.

9. The system of claim 6, wherein the terminal software state collection server, if the information about installation of software installed in the actual host changes, requests the virtual host to change a state of the installed software by providing notification.

10. A method of detecting malware based on a virtual host, comprising:
extracting, by a terminal network behavior analysis server, network behavior information by monitoring network behavior of an actual host;
transferring, by the terminal network behavior analysis server, the extracted the network behavior information to the virtual host; and
detecting, by the virtual host, malware corresponding to abnormal behavior in the actual host, by receiving the network behavior information and then performing corresponding behavior.

11. The method of claim 10, wherein the network behavior information comprises information attributable to behavior in which the actual host accesses a website, and information attributable to behavior in which the actual host reads a file over a network.

12. The method of claim 11, wherein the information attributable to behavior in which the actual host accesses a website comprises an IP address and a URL.

13. The method of claim 11, wherein the information attributable to behavior in which the actual host reads a file over a network comprises a file included in a network packet.

14. The method of claim 10, further comprising, before detecting the malware corresponding to the abnormal behavior, performing, by the virtual host, synchronization with the actual host with respect to information about installation and versions of software in order to perform network behavior of the actual host in an identical manner.

15. The method of claim 10, further comprising, before detecting the malware corresponding to the abnormal behavior, maintaining, by the terminal software state collection server, information about installation and versions of software installed on the actual host.
